(19) United States
(12) Patent Application Publication
(10) Pub. No.: US 2024/0154558 A1
(43) Pub. Date: May 9, 2024

(54) CONVERTER, AND METHOD FOR THE OPERATION OF A CONVERTER

(71) Applicant: LSP Innovative Automotive Systems GmbH, Unterföhring (DE)

(72) Inventors: Thomas LEIBER, Rogoznica (HR); Andrej JEREB, Munich (DE); Johannes ROSSMANN, Anzing (DE)

(21) Appl. No.: 18/278,785

(22) PCT Filed: Feb. 21, 2022
(86) PCT No.: PCT/EP2022/054239

§ 371 Date: Aug. 24, 2023

(30) Foreign Application Priority Data
Feb. 25, 2021 (DE) 10 2021 104 567.3

(51) Int. Cl. H02P 25/18; H02M 1/12; H02M 7/5387; H02P 27/06

(52) U.S. Cl. CPC H02P 25/18; H02M 1/12; H02M 7/53871; H02P 27/06

(57) ABSTRACT

A converter is configured for connection to an n-phase electric motor, n≥6. Coils associated with the n phases may form strands, at least two phases per strand. At least two of the at least two phases of a given strand may be connected in parallel or in series with one another as a function of at least one operating parameter of the electric motor or for setting an operating mode of the electric motor.

The invention relates to an inverter and a method of operating an inverter.

Converters for connection to and supply of electric motors are well known. In permanent magnet electric motors, an induced voltage is proportional to the speed. As a result, the induced voltage is very low at low speeds, which leads to low efficiency at such low speeds.

Furthermore, a low duty cycle causes a high and undesirable harmonic content in the current waveform. This high harmonic content is the cause of undesirable losses within the electric motor and generally poor efficiency at low speeds. These disadvantages can be eliminated by increasing the magnetic flux. This reduces the basic control range of the electric motor and increases the field weakening range. In general and simplified terms, the basic operating range can be defined as the operating range in which the electric motor is operated at maximum voltage and nominal frequency. The field weakening range can be understood as an operating range of the electric motor in which the magnetic flux and thus the magnetic field is weakened in order to achieve an increase in speed, but at the expense of the torque.

The previously mentioned reduction of the basic operating range has a negative effect on the efficiency at higher speeds. In this context, a low magnetic flux leads to better efficiency at high speeds. The disadvantages of the respective operating ranges can be addressed, for example, with a multi-start gearbox, but this entails disadvantages in terms of incurred costs, weight and mechanical losses.

Furthermore, it is possible to change the interconnection, in particular the interconnection of the armature windings within the electric motor during operation (e.g. as a function of the speed) in order to reduce the motor losses described above.

A second aspect relates to a voltage variability of the supply voltage of the inverter or the electric motor. In particular, in case of a voltage supply by a battery, the supply voltage changes due to a discharge of the battery during operation of the electric motor. This variable battery voltage affects the control of the inverter as well as the harmonic content and thus the efficiency of the electric motor.

Furthermore, redundancy in electric motors is nowadays mandatory or relevant, especially in many areas of application. In this context, it must be ensured that in the event of a failure of one or more components, the electric motor continues to run with at least reduced power. Designs are known which enable redundancy, for example by means of double designs and/or a DC link tap via switches or diodes. However, such redundancies are sometimes costly and complex to implement.

Based on this, the invention is based on the task of specifying an inverter and a method for operating an inverter, with the aid of which the disadvantages described above are at least reduced.

With regard to the converter, the task is solved according to the invention by a converter with the features of claim 1. With regard to the method, the task is solved according to the invention by a method with the features of claim 10. Advantageous designs, further developments and variants are the subject of the subclaims.

In particular, the task directed to the inverter is solved by an inverter designed for connection to an n-phase electric motor, where n is an integer greater than or equal to 6. In other words, the problem is solved by an inverter for connection to an electric motor with a phase number n, where the phase number n is greater than or equal to 6.

Furthermore, each phase of the electric motor can have at least one coil. At least two phases are preferably combined into one phase. If the electric motor has six phases, for example, two phases can thus be combined to form a total of three phases. In addition, one of the at least two phases of the phase is electrically rotated by 180 degrees relative to the other phase of the phase. By electrically rotated by 180 degrees it can be understood that the two phases concerned are connected inverted to each other, i.e. if an electric current flows in one direction through one phase, it flows in the opposite direction through the inverted phase.

A first half of the phases may be connected via at least a first star point or via a first polygon circuit. Likewise, a second half of the phases is connected via at least a second star point or via a second polygon circuit. The polygon circuit may be, for example, a delta circuit. With reference to the above example with the 6-phase electric motor, three of the six phases are in each case interconnected via a star point or a polygon circuit, so that two star points are present in total.

The inverter also has n switching units, whereby one switching unit can be assigned to each phase and the switching units of the at least two phases of a strand can form a switching module. I.e. with reference to the above example of the 6-phase electric motor, the inverter has six switching units and three switching modules. In general, the number of present switching units corresponds to the number of phases of the electric motor or number of phases.

Each phase of a strand can be directly connected to one of the two switching units of the associated switching module. Directly connected means that no switching element is arranged between the switching unit or the switching module and the electric motor.

Each switching unit is also connected to a voltage supply unit, each switching unit having two supply switching elements for applying a supply voltage to the connected phase. The voltage supply unit can be a battery or another voltage source. In the context of the present application, the supply voltage may be an output voltage of the converter, i.e. the voltage applied to the electric motor. This voltage can, for example, be a modulated voltage, in particular an AC voltage.

The switching units of a switching module are connected to one another via an electrical connecting line, with one connecting switching element being arranged in each of the switching units of a switching module in the electrical connecting line. Two connection switching elements are thus arranged in each electrical connection line.

The supply switching elements and the connection switching elements can be transistors, e.g. MOSFET or IGBT. In general, any electronic (semiconductor) switching elements can be used as supply switching elements and/or connection switching elements.

Depending on at least one operating parameter of the electric motor and/or for setting an operating mode of the electric motor, a change of the interconnection of the respective at least two phases can take place. This change can be a change from a parallel connection of the at least two phases to a serial connection or a change from a serial connection to a parallel connection. Thus, in simplified terms, when the phases are connected in parallel, the electric current flows in parallel through the coils of the respective two phases of the strand. In the case of series connection of the two phases in each case, the electric current flows, in simplified terms, first through one of the two coils and then through the other coil of the two phases of the strand in each case.

The configuration of the inverter described above makes it possible to implement an inverter with only 18 switching elements (a total of only six connection switching elements and only twelve supply switching elements), which makes it possible to switch from a series connection to a parallel connection of the phases and vice versa during operation of the electric motor. In parallel connection, the twelve supply switching elements are active, while in series connection the six connection switching elements and six of the twelve supply switching elements are active. The term “active” can be understood that these switching elements are actuated in a clocked manner, while the other switching elements are in freewheeling mode, for example. By contrast, similar topologies known from the prior art usually have between 30 and more than 40 switching elements.

The possibility of switching over during operation of the electric motor with the aid of the converter according to the invention can overcome the disadvantages mentioned at the beginning. Hereby, on the one hand, a sufficient redundancy of the kind mentioned at the beginning can be created and, on the other hand, occurring motor losses can at least be reduced. The special advantages are explained in more detail below with reference to specific examples and embodiments.

In one embodiment, the at least one operating parameter is an operating mode, in particular an operation in the field weakening range or in the basic setting range. Alternatively or additionally, the one operating parameter is a current voltage level of the supply voltage and/or a failure of one or more operating elements. Alternatively or additionally, the at least one operating parameter can also be a speed of the electric motor. In this case, for example, a switchover can then take place at a predetermined speed in order to replace a gear arranged on the electric motor. An increase in efficiency can then be achieved by the changeover.

With regard to operation in the field weakening range or in the basic setting range, switching the connection can optimize the electric motor and thus at least minimize losses. If, for example, the electric motor is in the field weakening range and the phases are connected in series with each other, the inverter can switch to the parallel connection. This reduces the ohmic losses, in particular reactive current losses within the electric motor. Conversely, or analogously, when the motor is operated in the basic control range, it is possible to switch from a parallel connection of the phases to a series connection of the phases, which also reduces motor losses, in particular losses caused by harmonics.

With reference to the current voltage level of the supply voltage, a switchover from series connection to parallel connection or vice versa can take place if the current voltage level falls below a predetermined value, for example. The switching is thus performed as a function of the current voltage level. This can at least reduce the disadvantages already mentioned at the beginning in the case of fluctuating supply voltage, in particular in the case of a supply by means of one or more batteries.

Alternatively or additionally, the changeover from series connection to parallel connection or vice versa takes place depending on a failure of one or more operating elements. The operating elements can be understood as the switching elements (supply switching elements and connection switching elements) and/or the coils of the individual phases. This embodiment makes it possible in a simple manner to continue to operate the electric motor in the event of failure of one or more operating elements by switching from series connection to parallel connection.

In one embodiment, the converter comprises a control unit for actuating the switching elements, with the control unit being set up in such a way that, as a function of the at least one operating parameter of the electric motor or for setting the operating mode of the electric motor, the respective two phases of a strand are switched in parallel or in series with one another. Here, the control unit can also be connected to a voltage detection sensor, for example, which transmits to it the current voltage level of the supply voltage. This can then be used to initialize the aforementioned voltage-level-dependent switching by the control unit. It is self-evident that the control unit is set up to switch all switching elements of all switching units of the inverter accordingly.

In a further embodiment, the operating mode of the electric motor is an operation for a (temporary) torque increase, also referred to as “boost mode”, or a multilevel operation. Multilevel operation may be a fundamentally known operating mode of electric motors in which clocking or switching takes place as a function of an available voltage level or level. This results in a more accurate sinusoidal waveform of the supply voltage. During multilevel operation, for example, a switchover from series connection to parallel connection can take place during a sine cycle.

According to one embodiment, at least half of the phases are connected via a common star point or a common polygon connection, for example a delta connection.

Further, according to one embodiment, in star connection, the at least one first star point of the first half of the phases and the at least one second star point of the second half of the phases are separated. In other words, the two star circuits have separate star points. In principle, if there are several star points, for example 4 star points (two first star points of the first half of the phases and two second star points of the second half of the phases) in a 12-phase electric motor, these are also formed separately from each other. Such a connection has proven to be advantageous, particularly with regard to improved harmonic behavior.

According to a further development, a fuse unit, also referred to as a “circuit breaker unit”, is arranged between the inverter and the electric motor. The fuse unit, which preferably has at least one fuse switching element per phase, ensures preferably galvanic isolation of the converter from the electric motor in the event of a fault.

According to a further development, the switching units of the first half of the phases and the switching units of the second half of the phases are each connected to different voltage supply units. That is, the switching units of the first half of the phases are connected to a first voltage supply unit, for example, and the switching units of the second half of the phases are connected to a second voltage supply unit, for example. Thus, the inverter can be supplied twice, which creates another redundancy level or possibility with respect to the voltage supply. To create further redundancy, it is also possible to provide two microcontrollers.

In one embodiment, the switching units are arranged in a common construction unit and, in particular, integrated in a common construction unit. In other words, the supply switching elements, which serve to apply the supply voltage to the electric motor, and the connection switching elements, which realize a switchover from series to parallel connection and vice versa, are thus combined in a common construction unit. This saves space, weight and costs compared to the already known designs, in which the above-mentioned switching elements are usually implemented in separate units.

The inverter as well as the n-phase electric motor can serve, for example, as an electric drive (also referred to as a power pack) for various industrial applications and/or as a drive for vehicles.

Specifically, the problem directed to the method is solved by a method for operating an inverter connected to an n-phase electric motor, wherein
n is an integer greater than or equal to 6;
each phase has at least one coil;
in each case, at least two phases are combined into one strand;
one of the two phases of the strand is electrically rotated 180 degrees relative to the other phase of the strand, and
a first half of the phases are connected via at least a first star point or a first polygon circuit and a second half of the phases are connected via at least a second star point or a second polygon circuit,

the method comprising the following steps:
detecting at least one operating parameter of the n-phase electric motor or detecting an operating mode to be set;
switching of the respective at least two phases of a strand in parallel or in series with each other depending on the detected operating parameter or the operating mode to be set.

The converter is in particular the converter already described above. The advantages and preferred embodiments listed with regard to the converter are to be applied mutatis mutandis to the method and vice versa.

Examples of embodiments of the invention are explained in more detail below with reference to the figures. These show in partially greatly simplified representation:

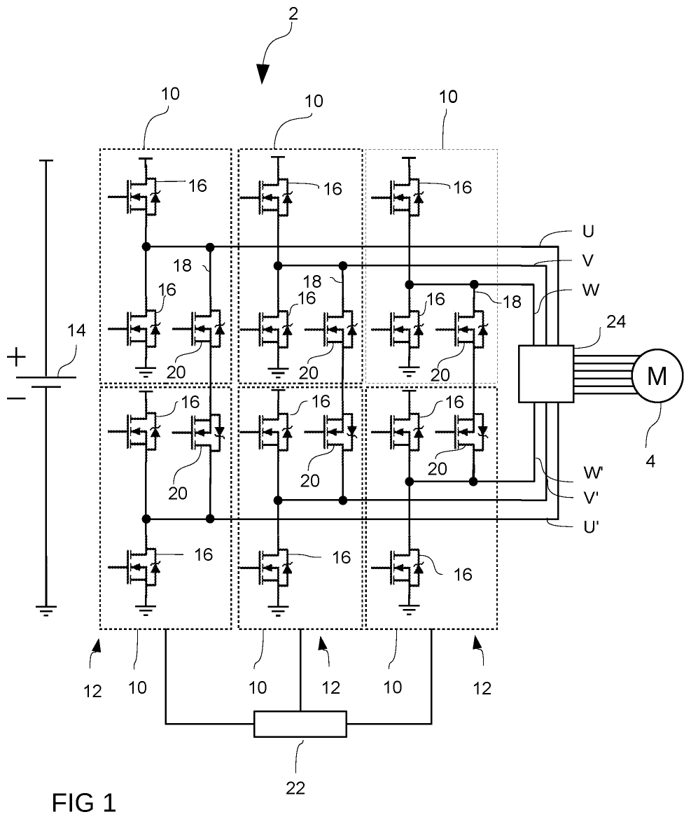

FIG. 1 simplified circuit diagram of the converter according to the invention according to a first embodiment, which is connected to an electric motor,

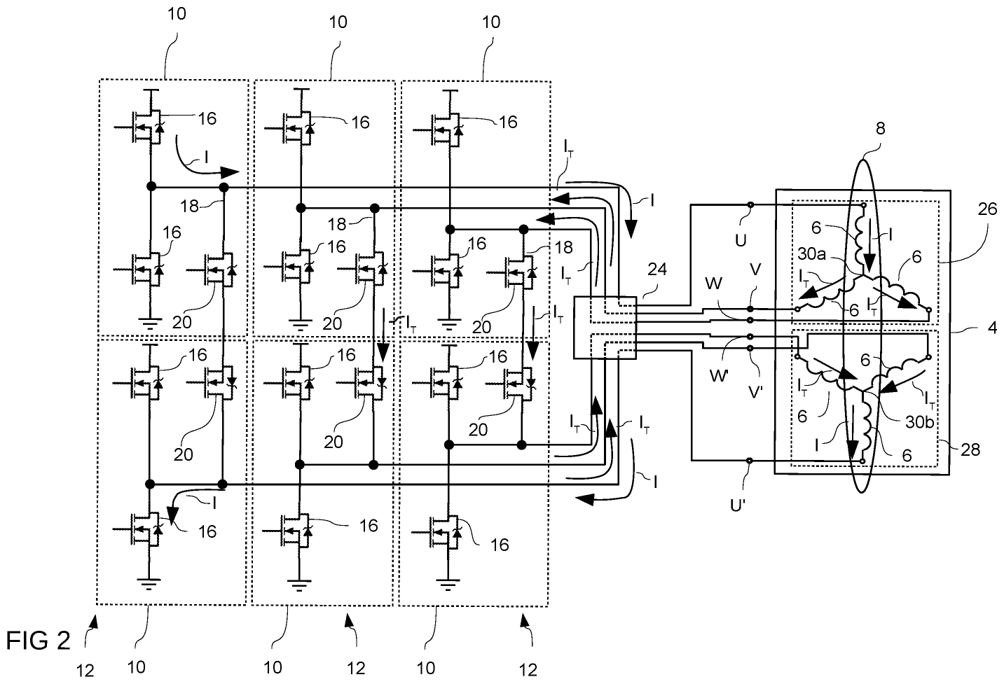

FIG. 2 shows the circuit diagram according to FIG. 1 with a current curve for series connection using the example of a phase,

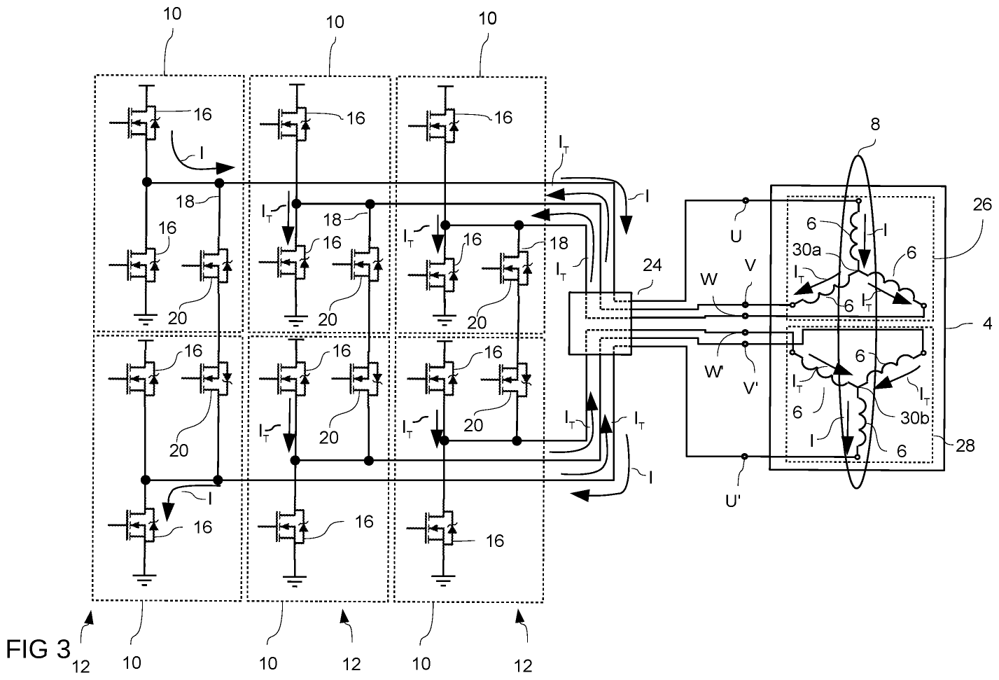

FIG. 3 shows the circuit diagram according to FIG. 1 with the course of a current in parallel connection for the example of one phase,

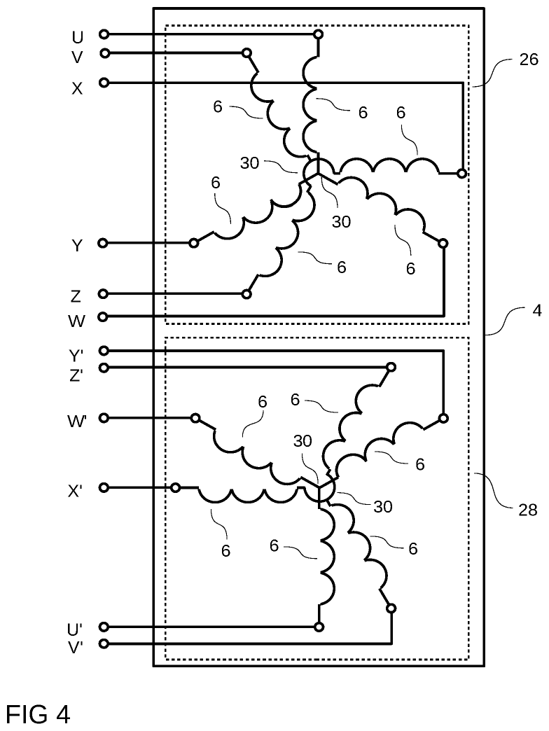

FIG. 4 sketched representation of a 12-phase system in star connection with separate star points in each case,

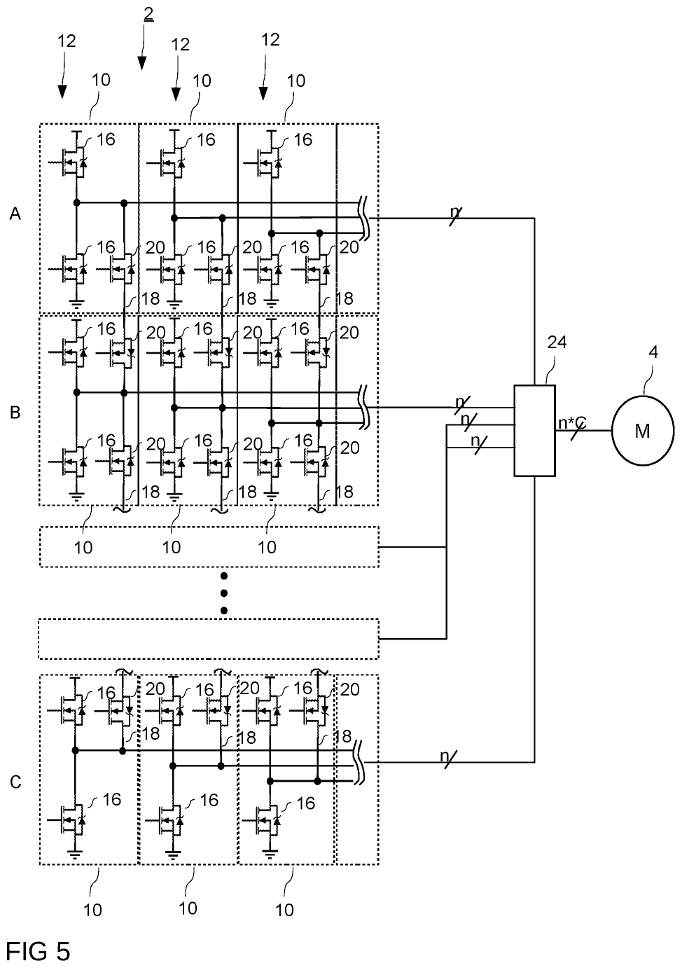

FIG. 5 simplified circuit diagram of the converter according to the invention for connection to an n-phase electric motor,

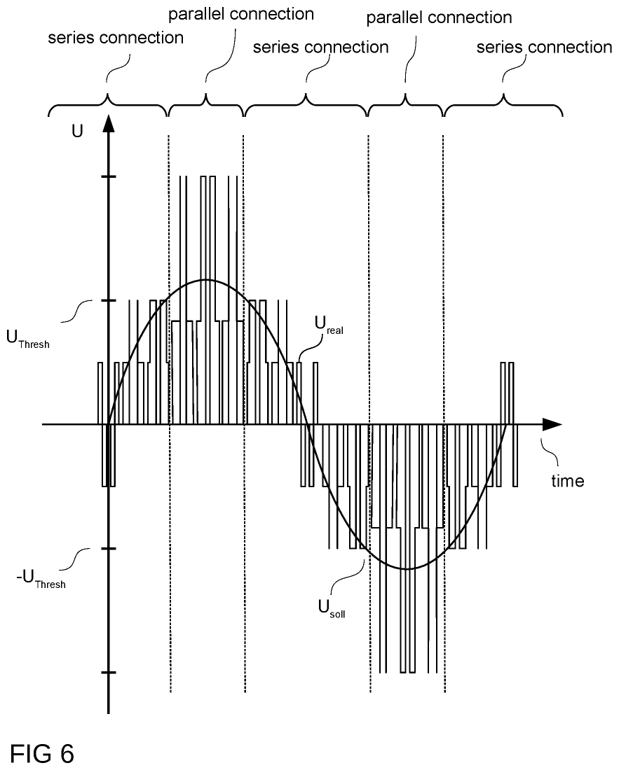

FIG. 6 sketched curve of the voltage during multilevel operation, which is realized by the converter according to the invention, as well as

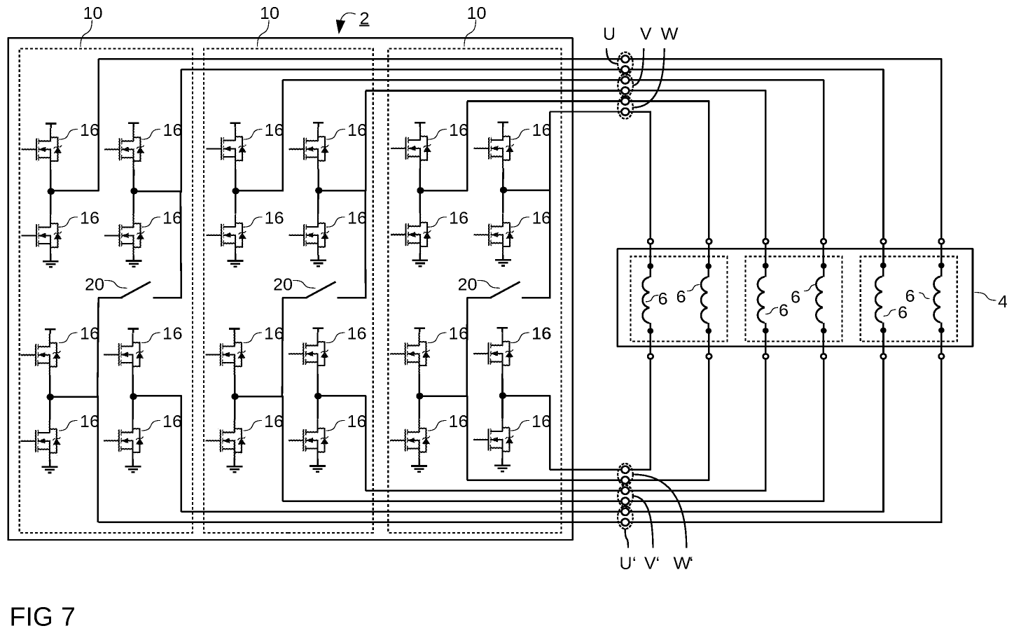

FIG. 7 an alternative embodiment of an inverter.

In the figures, components with the same effect are always shown with the same reference signs.

The converter 2 according to the invention shown in FIG. 1 is connected to an electric motor 4 with six phases U, V, W, U′, V′, W′, which is only shown schematically with a circle and its connections.

Each phase U, V, W, U′, V′, W′ has at least one coil 6 (see FIG. 2-5). In each case two phases U, V, W, U′, V′, W′ are combined to form a strand 8. A strand 8 is exemplarily shown in FIG. 2 by an encircling of the phases forming the respective strand 8. One of the two phases U, V, W, U′, V′, W′ of strand 8 is electrically rotated by 180 degrees relative to the other phase U, V, W, U′, V′, W′ of the same strand 8, i.e. switched inverted. The respective inverted phases U′, V′, W′ are marked with a dash. Thus, in the embodiment example, phase U′ is the phase switched inverted to phase U, phase V′ is the phase inverted to phase V, and phase W′ is the phase inverted to phase W.

In the embodiment example, the inverter 2 further comprises six switching units 10, which are shown by dashed rectangles. One switching unit 10 each is assigned to a phase U, V, W, U′, V′, W′. In addition, the switching units 10 of each of the two phases U, V, W, U′, V′, W′ of a strand 8 form a switching module 12. In the figures, the switching units 10, which are superimposed as seen in the illustration, each form a switching module 12, so that the converter 2 according to the invention as shown in FIG. 1 comprises three switching modules 12. Here, each phase U, V, W, U′, V′, W′ of a strand 8 is connected directly to one of the two switching units 10 of the associated switching module 12, i.e. without a component arranged in between. In other words, in the converter 2 according to FIG. 1—viewed in the image plane—the upper, left switching unit 10 is directly connected to the phase U, while the lower, left switching unit 10 is directly connected to the phase U′. The upper, left switching unit and the lower, left switching unit here form a previously mentioned switching module 12. Similarly, the upper, center switching unit 10 is directly connected to phase V, while the lower, center switching unit 10 is directly connected to phase V′. Further, the upper, right switching unit 10 is directly connected to phase W, while the lower, right switching unit 10 is directly connected to phase W′. In the figures, dots on two intersecting lines represent a conductive connection, while lines intersecting without a dot shown are not electrically connected.

Each switching unit 10 is connected to a voltage supply unit 14, shown only schematically, which applies a supply voltage to the individual phases U, V, W, U′, V′, W′. For this purpose, each switching unit 10 has two supply switching elements 16. In the embodiment example, the supply switching elements 16 are designed as MOSFETs. The supply voltage can be understood here, for example, as an output voltage of the inverter 2, which is applied to the electric motor 4.

In addition, the switching units 10 of a switching module 12 are connected to each other via an electrical connection line 18. A connection switching element 20 is arranged in each of the switching units 10 of a switching module 12. In other words, two connection switching elements 20 are thus arranged in each connection line 18, one of which is assigned to a switching unit 10 of the switching module 12 in each case, or is arranged there.

Depending on at least one operating parameter of the electric motor 4 or for setting an operating mode of the electric motor 4, the respective two phases U, V, W, U′, V′, W′ of a strand 8 are connected in parallel or in series with each other. For this purpose, the inverter 2 has a control unit 22 which is set up in such a way that the supply switching elements 16 and the connection switching elements 20 are controlled.

In addition, the inverter 2 has a fuse unit 24, which is also referred to as a “circuit breaker module” and is arranged between the electric motor 4 and the inverter 2. The fuse unit 24 usually has switching elements, not shown, which are configured to disconnect the electric motor 4, preferably galvanically, from the inverter 2 in the event of a fault.

The exact interconnection together with a current curve is explained below for some selected cases and phases U, V, W, U′, V′, W′. This applies analogously to the other cases and phases U, V, W, U′, V′, W′.

In FIG. 2, the circuit diagram of the inverter 2 according to FIG. 1 is shown again. The electric motor 4 is shown in FIG. 2 reduced only to the six phases U, V, W, U′, V′, W′. Furthermore, the interconnection or the connections of the individual phases U, V, W, U′, V′, W′ to the connections of the inverter 2 is shown in simplified form. The connection through the fuse unit 24 is only shown in simplified form by dashed lines.

As can be seen in FIG. 2, a first half 26 and a second half 28 of the phases U, V, W, U′, V′, W′ are each connected to each other via a common star point 30a, 30b. Here, the first star point of the first half 26 of the phases U, V, W, U′, V′, W′ is identified with the reference sign 30a and the second star point of the second half 28 of the phases U, V, W, U′, V′, W′ is identified with the reference sign 30b. In subsequent embodiments concerning both star points 30a, 30b, only the reference sign 30 is also used for the sake of simplicity. Alternatively, the first half 26 and the second half 28 are in each case connected to one another via a polygon circuit, in particular via a delta circuit. In other words, three phases each thus form a star circuit with a star point 30. Specifically, according to the embodiment in FIG. 2, the inverted phases and the non-inverted phases each form a half 26, 28, which are each connected via a common star point 30.

In the following, a current curve for a current I with series connection of the phases U, V, W, U′, V′, W′ is explained. Phase U and phase U′, which is connected inverted, are used as an example here. The left-hand switching module 12 is assigned to these phases, as seen in the image plane.

If terms such as upper or lower as well as right, center or left switching unit 10 are generally used in the following, this refers to the representation within the figures and is intended to serve a simpler understanding. In the following, a switching state is described in which switching elements not mentioned are closed, i.e. not permeably switched, unless something else is explicitly mentioned. The current flow is roughly marked by several arrows.

When a positive supply voltage is applied to the left-hand switching module 12, an electric current I flows through the upper supply switching element 16 of the upper, left-hand switching unit 10 and through the line connected thereto via the phase connection U into the electric motor 4. There, the current I flows through the coil 6 of the phase U in the direction of the star point 30a of the first half 26. At this star point 30a, the current I splits and flows through the coils 6 of the phases W and V respectively in the direction of the phase connections out of the electric motor 4. The partial current I_{T}, which flows back into the inverter 2 through the phase connection of phase W, flows through the electrical connection line 18 of the right-hand switching module 12 and thus through the connection switching element 20 of the upper, right-hand switching unit 10 and the lower, right-hand switching unit 10 before flowing back into the electric motor 4 again through the phase connection of phase W′. There, the partial current I_{T} flows via the coil 6 of the phase W′ into the star point 30b of the second half 28.

The partial current I_{T}, which flows back into the inverter 2 through the phase connection of the phase V, flows via the electrical connection line 18 of the middle switching module 12 and thus through the connection switching element 20 of the upper middle switching unit 10 and the lower middle switching unit 10 before flowing back into the electric motor 4 again via the phase connection of the phase V′. There, the partial current I_{T} also flows via the coil 6 of the phase V′ into the star point 30b of the second half 28.

The two partial currents I_{T} meeting in this star point 30b of the second half 28 then flow as one current I through the coil of phase U′ (here in the opposite direction than previously through the coil 6 of phase U) back into the converter 2, namely into the lower, left switching unit 10 and via the lower supply switching element 16 of the lower, left switching unit 10 to ground.

Similarly, the currents flow when the other phases are energized and in the opposite direction when a negative supply voltage is applied or during the negative half-wave in the case of an AC voltage. The only difference is that—with respect to the phase U—in the upper, left switching unit 10 the lower instead of the upper supply switching element 16 is connected through and in the lower, left switching unit 10 the upper instead of the lower supply switching element 16 is connected through.

However, it is self-evident that the above example only represents a specific, temporary switching state of the switching elements 16, 20 clocked during regular operation, e.g. by means of pulse width modulation. Furthermore, the current characteristic described above serves as a non-restrictive example of a current characteristic within the inverter 2 and the electric motor 4. Other current characteristics, which are made possible by the specified circuitry of the inverter, are also conceivable.

Particularly and essential to the invention is the electrical connection line 18 as well as the connection switching elements 20 arranged therein, which enable the compact design and the current flow described above as well as the series connection within the converter 2 according to the invention.

FIG. 3 now shows and explains the current flow using the example of phase U in a parallel circuit:

Here, the upper supply switching element 16 of the upper left switching unit 10 is permeably connected and an electric current I flows therethrough into the phase connection of phase U in the electric motor 4. There, the current I flows through the coil 6 of phase U into the star point 30a of the first half 26 and splits there. After the current I has flowed back in parts through the coils 6 of the phases W and V and their phase connections again into the inverter 2, the current parts I_{T} flow respectively via the lower supply switching elements 16 of both the upper, central switching unit 10 and the upper, right switching unit 10 to ground.

Similarly, an electrical partial current I_{T} flows simultaneously through each of the two upper supply switching elements 16 of the lower, central switching unit 10 and the lower, right switching unit 10. The two partial currents I_{T} then flow via the phase connections of phases W′ and V′ and through the coils 6 of phases W′ and V′ into the neutral point 30b of the second half 28. After the two partial currents I_{T} have merged there to form a current I, this flows through the coil 6 of phase U′ via the phase connection of phase U′ out of the electric motor 4 and into the inverter 2, where it flows off to ground through the lower supply switching element 16 of the lower, left-hand switching unit 10.

Basically, the parallel connection corresponds to an interconnection by means of six independent half bridges.

FIG. 4 shows a sketched representation of a twelve-phase system U, V, W, X, Y, Z, U′, V′, W′, X′, Y′, Z′ in star connection with separate star points 30 in each case. In such a configuration of the phases within the electric motor 4, three phases are connected together in each case to form a star and the star points 30 of the thus four separate star circuits are all separated from one another. This has proved to be advantageous, particularly with regard to the avoidance of undesirable harmonics.

FIG. 5 shows a schematic diagram of a circuit diagram of the inverter 2 according to the invention for an n-phase electric motor 4. For simplicity, only the inverter 2, the electric motor 4 and the fuse unit 24 are shown in FIG. 5.

According to the circuit diagram in FIG. 5, the switching units 10 are divided into three blocks, which are marked with the capital letters A, B, and C. The switching units 10 according to blocks A and C correspond to the switching units 10 already described above. The switching units 10 according to block B differ from the switching units 10 of blocks A and C in that they each have two connection switching elements 20. This embodiment is based on the idea that the switching units 10 according to block B serve as “connection units” and thus connect the switching units 10 according to block A and the switching units 10 according to block C with each other if the electric motor has several phases and in particular more than the six phases described so far. In an embodiment of the inverter 2 with, for example, nine switching units 10, i.e. blocks A, B and C with three switching units 10 each, a 9-phase electric motor can be operated. In order to operate further multi-phase electric motors 4, block B can be arranged several times between block A and block C. Alternatively or supplementarily, several switching units 10 (shown schematically by dotted lines at the respective right-hand end of blocks A, B, C) can be provided per block in order to be able to cover several phases per block. The modularity of the converter 2 according to the invention shown in FIG. 5 thus allows it to be adapted to multiphase electric motors 4.

FIG. 6 shows a sketched curve of the voltage U or the switching intervals from parallel connection to series connection and vice versa of the inverter 2 during multilevel operation.

The reference sign U_{schwell} indicates the voltage value at which the switchover between the series circuit and the parallel circuit takes place. This is also shown graphically in FIG. 6 by vertical lines and the curved brackets above the respective switching range. A sinusoidal reference voltage Uₛₒₗₗ is set by the clocked, real voltage Uᵣₑₐₗ. Since the multilevel operation of inverters is known in principle, no further detailed explanations are given.

FIG. 7 shows an alternative example of the inverter 2. Here, each switching unit 10 has eight supply switching elements 16 and a connection switching element 20, which is only shown schematically. FIG. 6 shows an inverter 2 for operating an electric motor 4 with six phases (U, V, W, U′, V′, W′).

The invention is not limited to the embodiments described above. Rather, other variants of the invention can also be derived therefrom by the person skilled in the art without leaving the object of the invention. Furthermore, in particular, all individual features described in connection with the embodiment examples can also be combined with each other in other ways without leaving the object of the invention.

### LIST OF REFERENCE SIGNS

2 inverter
4 electric motor
6 coil
8 strand
10 switching unit
12 switching module
14 voltage supply unit
16 supply switching element
18 electrical connection line
20 connection switching element
22 control unit
24 fuse unit
26 first half of phases
28 second half of the phases
30a first star point of the first half of the phases
30b second star point of the second half of the phases
U phase of electric motor
V phase of electric motor
W phase of electric motor
X phase of electric motor
Y phase of electric motor
Z phase of electric motor
U′ inverted phase of electric motor
V′ inverted phase of electric motor
W′ inverted phase of electric motor
X′ inverted phase of the electric motor
Y′ inverted phase of the electric motor
Z′ inverted phase of the electric motor
I current
I_{T} partial current
A first block of switching elements
B second block of switching elements
C third block of switching elements
U_{schwell} threshold voltage value for switching
Uᵣₑₐₗ real voltage value
Uₛₒₗₗ set voltage value

1. A converter configured to be connected to an n-phase electric motor, where n is an integer greater than or equal to 6, the converter including:
at least one respective coil corresponding to a respective one of the n phases, wherein at least two of the n phases are combined to form a strand, wherein, for a given strand, one of the at least two of the n phases of the strand is electrically rotated by 180 degrees relative to another one of the at least two phases of the strand, and wherein a first half of the n phases are connected via at least a first star point or a first polygon circuit and a second half of the n phases are connected via at least a second star point or a second polygon circuit,
n switching units, each case of the n switching units being assigned to a respective one of the n phases, wherein the switching units assigned to the at least two phases of a given strand forming a switching module, wherein:
each phase of the given strand is directly connected to a respective one of the two switching units of the associated switching module of the given strand;
each switching unit is connected to a voltage supply unit, each switching unit having two supply switching elements arranged to apply a supply voltage to the assigned phase; and
the switching units of a switching module are connected to one another via an electrical connection line, with a connection switching element being arranged in each of the switching units of a switching module in the electrical connection line, so that depending on at least one operating parameter of the electric motor and/or for setting an operating mode of the electric motor, the respective at least two phases of the given strand are connected in parallel or in series with one another.

2. The converter according to claim 1, wherein the at least one operating parameter is an operating mode, in a field weakening range or in a basic setting range, and/or a current voltage level of the supply voltage and/or a failure of one or more operating elements.

3. The converter according to claim 2, further including:
a control unit arranged to actuate the supply switching elements and the connection switching elements, the control unit being set up in such a way that, as a function of the at least one operating parameter of the electric motor or in order to set the operating mode of the electric motor, the respective at least two phases of the given strand are connected in parallel or in series with one another.

4. The converter according to claim 2, wherein the operating mode is an operation of the electric motor to perform a torque increase or a multilevel operation.

5. The converter according to claim 1, wherein at least half of the n phases are connected via a common star point or a polygon circuit.

6. The converter according to claim 1, wherein, in the case of star connection, the at least one first star point of the first half of the n phases and the at least one second star point of the second half of the n phases are separated.

7. The converter according to claim 1, further including:
a fuse unit arranged between the converter and the electric motor.

8. The converter according to claim 1, wherein the switching units of the first half of the phases and the switching units of the second half of the phases are connected to different respective voltage supply units.

9. The converter according to claim 1, wherein the switching units are arranged in a common unit.

10. A method of operating the converter according to claim 1, which is connected to an n-phase electric motor,
the method comprising:
detecting at least one operating parameter of the n-phase electric motor and/or detecting an operating mode to be set; and
switching of respective at least two phases of the given strand in parallel or in series with each other depending on the detected operating parameter or the operating mode to be set.
